(19) United States
(12) Patent Application Publication
(10) Pub. No.: US 2026/0101043 A1
(43) Pub. Date: Apr. 9, 2026

(54) EFFICIENT SIGNALING FOR TEMPORAL INTERPOLATED PREDICTION

(71) Applicant: Tencent America LLC, Palo Alto, CA (US)

(72) Inventors: Ting-Lan LIN, Palo Alto, CA (US); Liang ZHAO, Palo Alto, CA (US); Madhu PERINGASSERY KRISHNAN, Palo Alto, CA (US); Tianqi LIU, Palo Alto, CA (US); Shan LIU, Palo Alto, CA (US)

(21) Appl. No.: 19/352,323

(22) Filed: Oct. 7, 2025

Related U.S. Application Data
(60) Provisional application No. 63/705,478, filed on Oct. 9, 2024.

(51) Int. Cl. H04N 19/139; H04N 19/159; H04N 19/172; H04N 19/70

(52) U.S. Cl. CPC H04N 19/139; H04N 19/159; H04N 19/172; H04N 19/70

(57) ABSTRACT

An example method includes receiving a video bitstream comprising a plurality of frames, including a current frame encoded in a temporal interpolated predicted (TIP) mode. The method includes when the current frame has a non-zero motion vector, parsing an indicator from the video bitstream. The indicator indicates whether an adaptive motion vector difference (AMVD) mode is enabled for the current frame. The method includes reconstructing the current frame using the TIP mode and the AMVD mode based on the indicator. The method also includes when the current frame does not have the non-zero motion vector, reconstructing the current frame using the TIP mode without the AMVD mode, where the video bitstream does not include the indicator.

### RELATED APPLICATIONS

This application claims priority to U.S. Provisional Patent Application No. 63/705,478, entitled “Efficient Signaling for Temporal Interpolated Prediction,” filed Oct. 9, 2024, which is hereby incorporated by reference in its entirety.

### TECHNICAL FIELD

The disclosed embodiments relate generally to video coding, including but not limited to systems and methods for motion vector estimation and signaling for temporal interpolated prediction (TIP) mode.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

The present disclosure describes methods, systems, and non-transitory computer-readable storage media for applying a temporal interpolated prediction (TIP) mode during video (image) compression. A video codec includes a plurality of function modules for one or more of: intra/inter prediction, transform coding, quantization, entropy coding, and in-loop filtering. Inter prediction predicts the content of the current video frame using blocks from previously coded frames (reference frames) rather than just the pixels within the same frame. TIP mode is an inter coding tool where a TIP frame can be interpolated with forward and backward reference frames. The TIP frame can serve as a reference frame or can be directly output for display purpose (e.g., as TIP direct output mode). Adaptive motion vector difference (AMVD) mode involves coding motion vector differences (MVDs) with varying resolutions. For example, decreasing resolution (e.g., integer pixel resolution or fractional pixel resolution) for larger MVD magnitude ranges and/or with increasing resolution for smaller MVD magnitude ranges. As described herein, the TIP mode can be combined with the AMVD mode to achieve an overall better compression efficiency.

As an example, when the current frame has a non-zero motion vector, the decoder reconstructs the current frame using the TIP mode and the AMVD mode based on the indicator. When the current frame does not have a non-zero motion vector, the decoder the current frame using the TIP mode without the AMVD mode. The decoder may parse an indicator from the video bitstream that indicates whether an AMVD mode is enabled for the current frame. In this way, TIP mode may be combined with the AMVD mode.

In accordance with some embodiments, a method of video decoding includes (i) receiving a video bitstream comprising a plurality of frames, including a current frame encoded in TIP mode; (ii) when the current frame has a non-zero motion vector: parsing an indicator from the video bitstream, the indicator indicating whether an AMVD mode is enabled for the current frame; and reconstructing the current frame using the TIP mode and the AMVD mode based on the indicator; and (iii) when the current frame does not have the non-zero motion vector, reconstructing the current frame using the TIP mode without the AMVD mode, wherein the video bitstream does not include the indicator.

In accordance with some embodiments, a method of video encoding includes (i) receiving video data comprising a plurality of frames, including a current frame to be encoded in a TIP mode; (ii) when the current frame has a non-zero motion vector: signaling an indicator in a video bitstream, the indicator indicating that an AMVD mode is enabled for the current frame; and encoding the current frame using the TIP mode and the AMVD mode; and (iii) when the current frame does not have the non-zero motion vector, encoding the current frame using the TIP mode without the AMVD mode and without signaling the indicator.

In accordance with some embodiments, a method of storing a video bitstream that is generated by a video encoding method is provided. The video bitstream comprises (a) coded information for a plurality of frames including a current frame encoded in a TIP mode; and (b) when the current frame has a non-zero motion vector, an indicator indicating that an AMVD mode is enabled for the current frame. The video encoding method comprises: (i) when the current frame has a non-zero motion vector: signaling the indicator in a video bitstream; and encoding the current frame using the TIP mode and the AMVD mode; and (ii) when the current frame does not have the non-zero motion vector, encoding the current frame using the TIP mode without the AMVD mode and without signaling the indicator.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIGS. 4A-4D illustrate example coding tree structures in accordance with some embodiments.

FIG. 5A illustrates example motion vector candidate generation for a single inter prediction block in accordance with some embodiments.

FIG. 5B illustrates example motion vector candidate generation for a compound prediction block in accordance with some embodiments.

FIG. 6 illustrates an example TIP mode in accordance with some embodiments.

FIG. 7 illustrates an example where magnitudes of motion vectors are classified into three regions in accordance with some embodiments.

FIG. 8A illustrates an example video decoding process in accordance with some embodiments.

FIG. 8B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes methods, systems, and non-transitory computer-readable storage media for frame level motion vector estimation and signaling for temporal interpolated prediction mode. In various embodiments of this application, a video decoder receives a video bitstream from a video encoder, the video bitstream including a current frame in a TIP mode. The video decoder parses an indicator from the video bitstream when the current frame has a non-zero motion vector, the indicator indicating whether an AMVD mode is enabled for the current frame. The decoder reconstructs the current frame using the TIP mode and the AMVD mode based on the indicator. When the video bitstream does not include the indicator, the decoder reconstructs the current frame using the TIP mode without the AMVD mode. By intelligently applying TIP mode to an AMVD-enabled current frame when the current frame has a non-zero motion vector, coding efficiency is improved.

The present disclosure describes efficient methods for signaling and estimating frame-level motion vectors in TIP modes for video coding. By adaptively signaling motion vector differences based on the magnitude of the motion vectors, coarser precision may be used for larger motion vectors and finer precision for smaller ones, optimizing the bitstream and reducing unnecessary signaling overhead. The use of look-up tables with power-of-two entries for motion vector components further streamlines the encoding and decoding processes. These techniques described herein allow TIP frames to be used either as reference frames or for direct output, with frame-level displacement mitigated through precise motion estimation and signaling. In this way, improved compression efficiency, reduced bitstream size, and lower computational complexity may be achieved, all of which contribute to enhanced video quality and more efficient storage and transmission in bandwidth-constrained environments.

### Example Systems and Devices

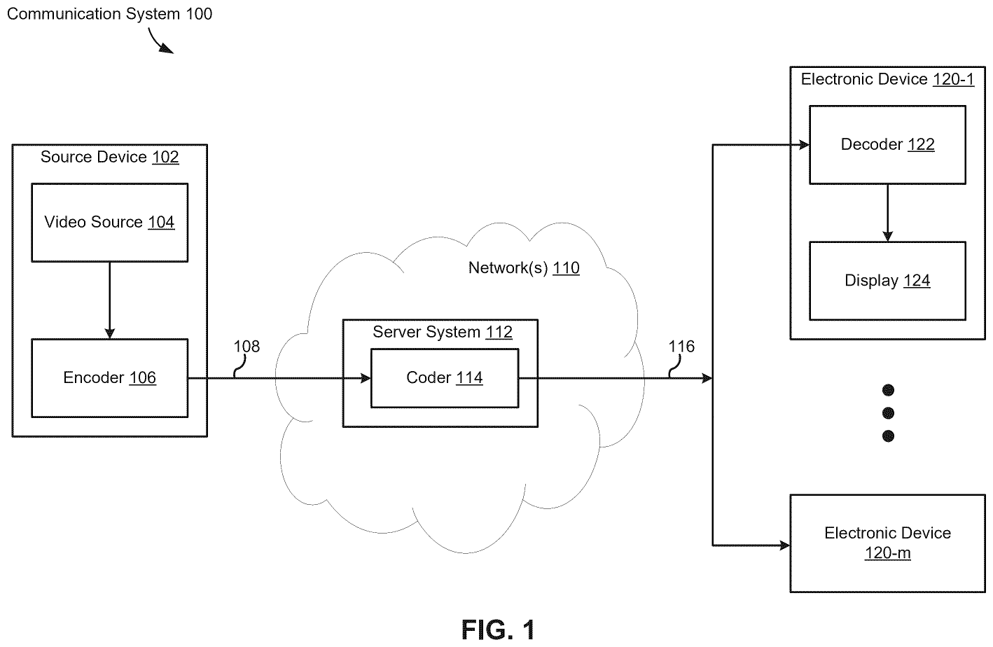

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

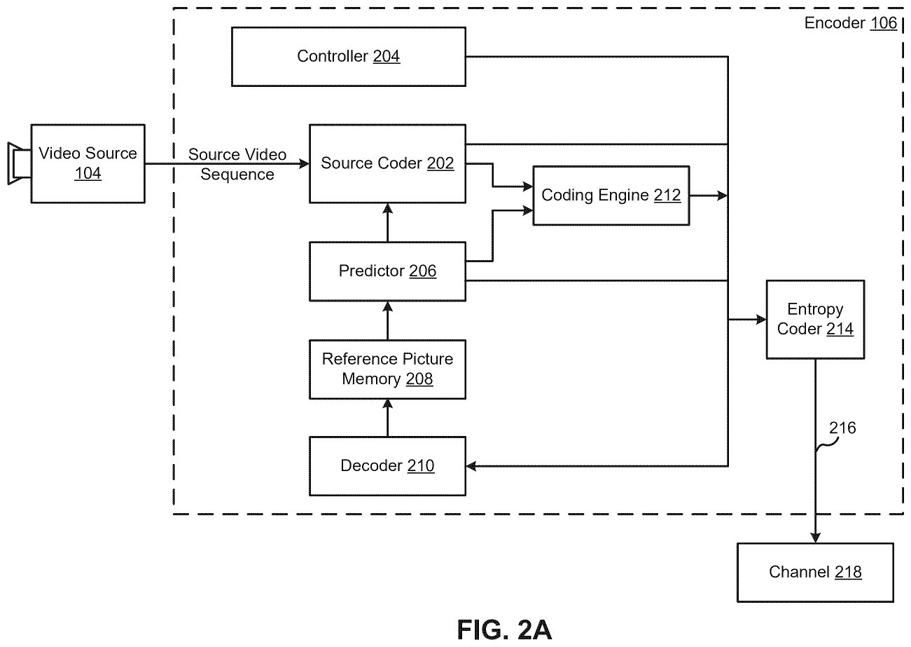

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

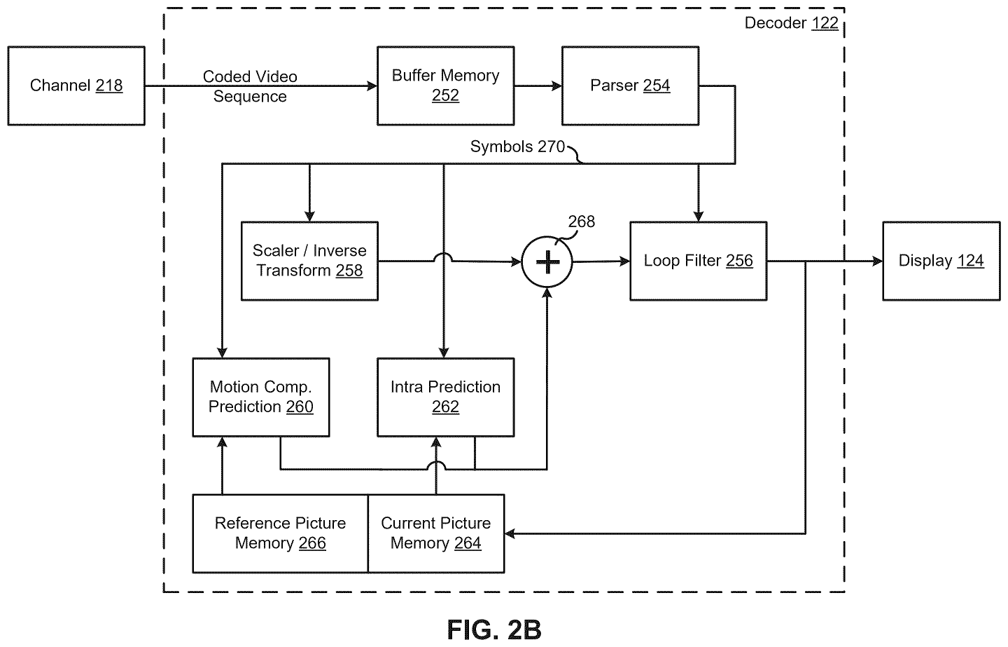

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). According to some embodiments, methods for motion vector estimation and signaling for TIP mode are described below. First, block and transform partitioning are described.

Block partitioning and transform partitioning are distinct processes in video coding. Block partitioning refers to dividing a video frame into smaller spatial regions, or blocks, which are then individually processed for prediction and encoding. This enables the codec to adapt to local image characteristics and efficiently exploit spatial and temporal redundancies. Transform partitioning, on the other hand, involves subdividing these blocks further for the purpose of applying mathematical transforms, such as discrete cosine transforms, to the residual data after prediction. While block partitioning optimizes prediction accuracy and coding flexibility, transform partitioning is focused on improving the efficiency of residual data representation and compression.

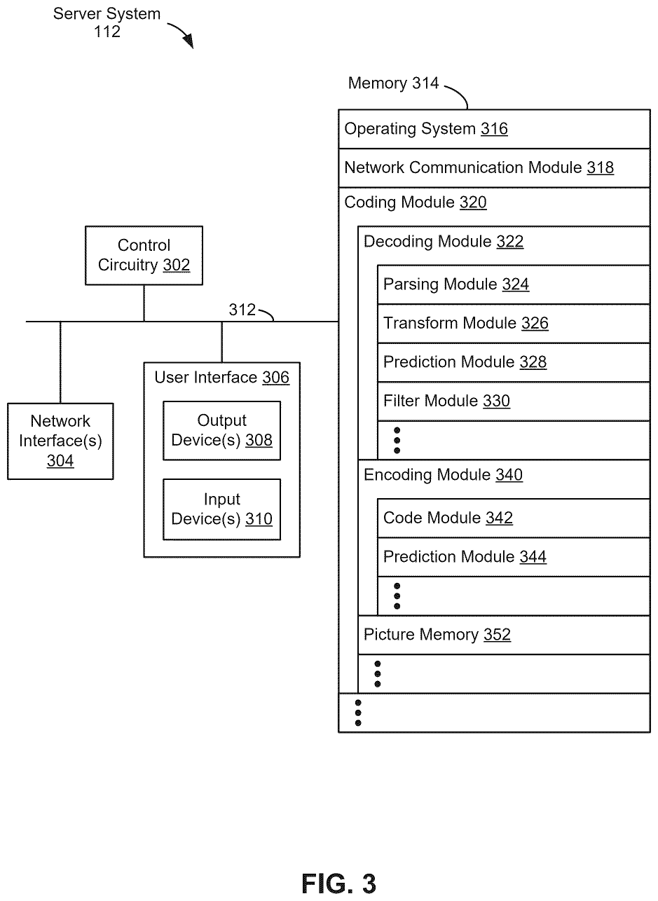

FIGS. 4A-4D illustrate example coding tree structures in accordance with some embodiments. As shown in a first coding tree structure (400) in FIG. 4A, some coding approaches (e.g., VP9) use a 4-way partition tree starting from a 64×64 level down to a 4×4 level, with some additional restrictions for blocks 8×8. In FIG. 4A, partitions designated as R can be referred to as recursive in that the same partition tree is repeated at a lower scale until the lowest 4×4 level is reached. As shown in a second coding tree structure (402) in FIG. 4B, some coding approaches (e.g., AV1) expand the partition tree to a 10-way structure and increase the largest size (e.g., referred to as a superblock in VP9/AV1 parlance) to start from 128×128. The second coding tree structure includes 4:1/1:4 rectangular partitions that are not in the first coding tree structure. The partition types with 3 sub-partitions in the second row of FIG. 4B are referred to as T-type partitions. In addition to a coding block size, coding tree depth can be defined to indicate the splitting depth from the root note.

As an example, a CTU may be split into CUs by using a quad-tree structure denoted as a coding tree to adapt to various local characteristics, such as in HEVC. In some embodiments, the decision on whether to code a picture area using inter-picture (temporal) or intra-picture (spatial) prediction is made at the CU level. Each CU can be further split into one, two, or four PUs according to the PU splitting type. Inside one PU, the same prediction process is applied, and the relevant information is transmitted to the decoder on a PU basis. After obtaining the residual block by applying the prediction process based on the PU splitting type, a CU can be partitioned into TUs according to another quad-tree structure like the coding tree for the CU.

A quad-tree with nested multi-type tree using binary and ternary splits segmentation structure may replace the concepts of multiple partition unit types, e.g., it removes the separation of the CU, PU, and TU concepts except as needed for CUs that have a size too large for the maximum transform length, and supports more flexibility for CU partition shapes. In the coding tree structure, a CU can have either a square or rectangular shape. A CTU is first partitioned by a quaternary tree (also referred to as quad-tree) structure. The quaternary tree leaf nodes can be further partitioned by a multi-type tree structure. A third coding tree structure (404) in FIG. 4C shows the multi-type tree structure includes four splitting types. The multi-type tree leaf nodes are called CUs, and unless the CU is too large for the maximum transform length, this segmentation is used for prediction and transform processing without any further partitioning. This means that, in most cases, the CU, PU, and TU have the same block size in the quad-tree with nested multi-type tree coding block structure. An example of block partitions for one CTU (406) is shown in FIG. 4D, which illustrates an example quadtree with nested multi-type tree coding block structure.

In accordance with some embodiments, transform partitioning is indicated by the flag “do_partition flag=1.” In some systems, if a current block can support both horizontal and vertical split (e.g., illustrated in FIGS. 4A-4D), the transform partition type is signaled using five symbols. However, in these systems, if the current block can support just one of horizontal or vertical split, the transform partition type is still signaled using five symbols. This leads to excessive signaling overhead and coding complexity. In accordance with some embodiments, the redundancy caused by use of five symbols to indicate a two-symbol event (e.g., 2-way partition or 3-way partition) is removed. For example, the horizontal or vertical split is signaled using two symbols.

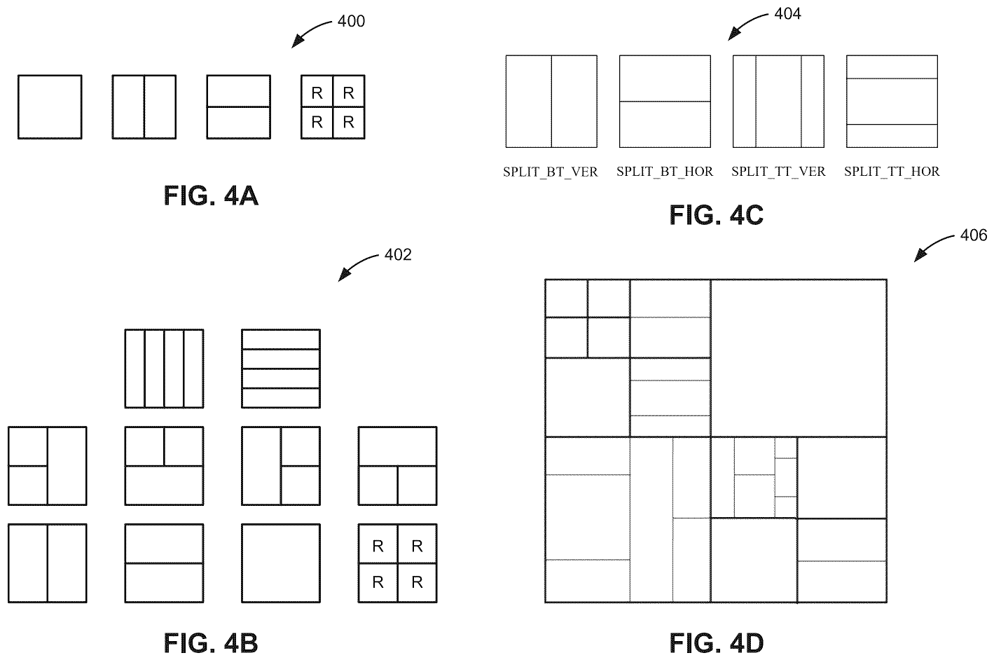

FIG. 5A illustrates example motion vector candidate generation for a single inter prediction block in accordance with some embodiments. As shown in FIG. 5A, the mv1 from the neighboring block, A, is utilized to derive the MVP for the motion vector, mv0, of current block with temporal scaling. For compound inter prediction, the composed MVs from different neighboring blocks are exploited to derive an MVP of the current block, but the reference frames of the composed MVs need to be the same as current block. FIG. 5B illustrates example motion vector candidate generation for a compound prediction block in accordance with some embodiments. FIG. 5B shows the composed MV (mv2, mv3) have the same reference frames as the current block but are from different neighboring blocks.

As mentioned above, an inter-coded block may employ one or more associated motion vectors. In some embodiments, a syntax is signaled in the bitstream to indicate whether the block is single inter prediction mode (e.g., the block is encoded using motion information from one reference block) or compound inter prediction mode (e.g., the block is encoded using motion information from two or more reference blocks). Single prediction mode has one associated motion vector whereas compound inter prediction mode has multiple associated motion vectors.

Table 1 details single inter prediction modes according to some embodiments.

TABLE 1
Single Inter Prediction Modes

| Modes | Description |
|---|---|
| NEARMV | Use one of the motion vector predictors (MVP) in the list |
| | indicated by a DRL (Dynamic Reference List) index |
| NEWMV | Use one of the motion vector predictors (MVP) in the list |
| | signaled by a DRL index as reference and apply a delta |
| | to the MVP |
| GLOBALMV | Use a motion vector based on frame-level global motion |
| | parameters |

For compound inter prediction mode, multiple reference blocks can be from the same reference frame. In some embodiments, for compound inter prediction mode, the two reference blocks can be from different reference frames. For compound reference case, the compound inter prediction modes detailed in Table 2 below can be used.

TABLE 2
Compound Reference Modes

| Modes | Description |
|---|---|
| NEAR_NEARMV | No motion vector difference (MVD) for both |
| | two reference frames |
| NEAR_NEWMV | No MVD for the first reference frame, and |
| | with MVD for the second reference frame |
| NEW_NEARMV | With MVD for the first reference frame, and |
| | no MVD for the second reference frame |
| NEW_NEWMV | With MVD for both two reference frames |
| GLOBAL_GLOBALMV | No MVD for both two reference frames |
| JOINT_NEWMV | Joint MVD for both reference frames |
| JOINT_AMVDNEWMV | Joint MVD for both reference frames, with |
| | adaptive MVD based MVD signaling |

AMVD mode is a video coding technique that adjusts the precision of motion vector signaling based on the magnitude of the motion vector. In AMVD mode, larger motion vectors are represented with coarser precision, while smaller motion vectors are signaled with finer precision. This adaptive approach reduces the number of bits required for signaling motion vectors, especially when high precision is unnecessary for large displacements, thereby improving overall compression efficiency. By tailoring the resolution of motion vector differences to their magnitude, AMVD mode helps minimize bitstream overhead and enhances coding performance in various video compression scenarios.

In some embodiments, a predefined resolution for the MVD is allowed. For example, a ⅛-pixel motion vector precision (or accuracy) may be allowed. The MVD described above in the various MV prediction modes may be constructed and signaled in various manners. In some embodiments, various syntax elements are used to signal the motion vector difference(s) above in reference frame list 0 or list 1. For example, a syntax element referred to as “mv_joint” may specify which components of the motion vector difference associated therewith are non-zero. For an MVD, this is jointly signaled for all the non-zero components. For example, for mv_joint:
may indicate that there is no non-zero MVD along either the horizontal or the vertical direction
1 may indicate that there is non-zero MVD only along the horizontal direction
2 may indicate that there is non-zero MVD only along the vertical direction
3 may indicate that there is non-zero MVD along both the horizontal and the vertical directions.

In some embodiments, when the “mv_joint” syntax element for an MVD signals that there is no non-zero MVD component, then no further MVD information is signaled. However, if the “mv_joint” syntax signals that there is one or two non-zero components, then additional syntax elements may be further signaled for each of the non-zero MVD components as described below. In one example, a syntax element referred to as “mv_sign” may be used to additionally specify whether the corresponding motion vector difference component is positive or negative. In another example, a syntax element referred to as “mv_class” may be used to specify a class of the motion vector difference among a predefined set of classes for the corresponding non-zero MVD component. The predefined classes for motion vector difference, for example, may be used to divide a contiguous magnitude space of the motion vector difference into non-overlapping ranges with each range corresponding to an MVD class. A signaled MVD class thus indicates the magnitude range of the corresponding MVD component. In the example of Table 3, a higher class corresponds to motion vector differences having range of a larger magnitude. The symbol (n, m] is used for representing a range of motion vector difference that is greater than n pixels, and smaller than or equal to m pixels.

TABLE 3
Magnitude class for motion vector difference

| MV class | Magnitude of MVD |
|---|---|
| MV_CLASS_0 | (0, 2] |
| MV_CLASS_1 | (2, 4] |
| MV_CLASS_2 | (4, 8] |
| MV_CLASS_3 | (8, 16] |
| MV_CLASS_4 | (16, 32] |
| MV_CLASS_5 | (32, 64] |
| MV_CLASS_6 | (64, 128] |
| MV_CLASS_7 | (128, 256] |
| MV_CLASS_8 | (256, 512] |
| MV_CLASS_9 | (512, 1024] |
| MV_CLASS_10 | (1024, 2048] |

In some embodiments, fractional resolution is independent of different classes of MVD. In other words, regardless of the magnitude of the motion vector difference, similar options for motion vector resolution may be provided using a predefined number of bits for signaling the fractional MVD of a non-zero MVD component. In some embodiments, resolution for motion vector difference in various MVD magnitude classes are differentiated. Specifically, high resolution MVD for large MVD magnitude of higher MVD classes may not provide statistically significant improvement in compression efficiency. As such, the MVDs may be coded with decreasing resolution (integer pixel resolution or fractional pixel resolution) for larger MVD magnitude ranges, which correspond to higher MVD magnitude classes. Likewise, the MVD may be coded with decreasing resolution (integer pixel resolution or fractional pixel resolution) for larger MVD values in general. Such MVD class-dependent or MVD magnitude-dependent MVD resolution may be generally referred to as adaptive MVD (AMVD) resolution, amplitude-dependent adaptive MVD resolution, or magnitude-dependent MVD resolution. The term “resolution” may be further referred to as “pixel resolution” AMVD resolution may be implemented in various matter as described by the example implementations below for achieving an overall better compression efficiency. In particular, the reduction of number of signaling bits by aiming at less precise MVD may be greater than the additional bits needed for coding inter-prediction residual as a result of such less precise MVD, due to the statistical observation that treating MVD resolution for large-magnitude or high-class MVD at similar level as that for low-magnitude or low-class MVD in a non-adapted manner may not significantly increase inter-prediction residual coding efficiency for bocks with large-magnitude or high-class MVD. In other words, using higher MVD resolutions for large-magnitudes or high-class MVD may not produce much coding gain over using lower MVD resolutions.

In some embodiments, the pixel resolution or precision for MVD decreases (or is non-increasing) with increasing MVD class. Decreasing pixel resolution for the MVD corresponds to coarser MVD (or larger step from one MVD level to the next). In some embodiments, the correspondence between an MVD pixel resolution and MVD class is specified, predefined, or pre-configured and thus may not need to be signaled in the encode bitstream.

In some embodiments, the MV classes of Table 3 are each associated with different MVD pixel resolutions. In some embodiments, each MVD class is associated with a single allowed resolution. In some embodiments, one or more MVD classes are associated with two or more optional MVD pixel resolutions. A signal in a bitstream for a current MVD component with such an MVD class may thus be followed by an additional signaling for indicating which optional pixel resolution is selected for the current MVD component. In some embodiments, the adaptively allowed MVD pixel resolution includes 1/64-pel (pixel), 1/32-pel, 1/16-pel, ⅛-pel, 1-4-pel, ½-pel, 1-pel, 2-pel, 4-pel . . . (in descending order of resolution). As such, each one of the ascending MVD classes may be associated with one of these resolutions in a non-ascending manner. In some implementations, an MVD class may be associated with two or more resolutions above and the higher resolution may be lower than or equal to the lower resolution for the preceding MVD class. For example, if the MV_CLASS_3 of Table 3 may be associated with optional 1-pel and 2-pel resolution, then the highest resolution that MV_CLASS_4 of Table 3 could be associated with would be 2-pel. In some embodiments, the highest allowable resolution for an MV class may be higher than the lowest allowable resolution of a preceding (lower) MV class. The average of allowed resolution for ascending MV classes may be non-ascending.

In some embodiments, fractional pixel resolution is only allowed for MVD classes below or equal to a threshold MVD class. For example, fractional pixel resolution may only be allowed for MVD-CLASS 0 and disallowed for all other MV classes of Table 3. Likewise, fractional pixel resolution may only be allowed for MVD classes below or equal to any one of other MV classes of Table 3. For the other MVD classes above the threshold MVD class, only integer pixel resolutions for MVD are allowed.

In some embodiments, fractional pixel resolution is only allowed for MVD with integer value below a threshold integer pixel value. For example, fractional pixel resolution may only be allowed for MVD smaller than 5 pixels. Corresponding to this example, fractional resolution may be allowed for MV_CLASS_0 and MV_CLASS_1 of Table 3 and disallowed for all other MV classes. In some embodiments, the pixel resolution or precision for MVD may decrease or may be non-increasing with increase MVD magnitude. For example, the pixel resolution may depend on integer portion of the MVD magnitude. In some implementations, fractional pixel resolution is allowed only for MVD magnitude smaller than or equal to an amplitude threshold. For a decoder, the integer portion of the MVD magnitude may first be extracted from a bitstream. The pixel resolution may then be determined, and decision may then be made as to whether any fractional MVD is in existence in the bit stream and needs to be parsed (e.g., if the fractional pixel resolution is disallowed for a particular extracted MVD integer magnitude, then no fractional MVD bits may be included in the bitstream needing extraction). The example implementations above related to MVD-class-dependent adaptive MVD pixel resolution applies to MVD magnitude dependent adaptive MVD pixel resolution. For a particular example, MVD classes above or encompassing the magnitude threshold may be allowed to have only one predefined value.

The various example implementations above can apply to single-reference mode, or to the NEW_NEARMV, NEAR_NEWMV, and/or NEW_NEWMV modes in compound prediction under MMVD, and/or to adaptive resolution for any MVD.

In an example for AMVD pixel resolution, the MVD pixel resolution for MVD magnitude below 1 may be fractional, and for MV class of MV_CLASS_1 and above, only a single MVD magnitude equal to the ending value of the corresponding MVD magnitude range of Table 3 may be allowed. In such an example, the allowed MVD values are indicated in Table 3 for allowed fractional pixel resolution of ⅛, ¼, or ½ pixel. When AMVD pixel resolution is signaled as being used, the allowed MVD levels or values in an adaptive manner may be predefined or may be signaled. For example, they may be signaled in the bitstream in various manners depending on the particular scheme for AMVD resolution. For example, a set of signaling syntax may be used to indicate the fractional resolution (e.g., ⅛ pixel), the magnitude threshold below which the signaled fractional resolution applies (e.g., MVD magnitude of 1 pixel). Another sets of syntax (which may be more complex) may be used signal other AMVD resolution scheme. Such indication of the AMVD pixel resolution scheme may be signaled at one of various coding levels, such as the sequence level, the picture level, the frame level, the slice level, the super block level, or the coding block level.

The example implementations above are described with respect to a particular MVD irrespective of whether the inter-prediction mode is either in the single-reference mode or compound-reference mode. In some other example implementations in the compound-reference mode, where an MV is predicted by multiple reference frames, a set of definition/signaling may be used to indicate whether an AMVD resolution is applied and which one(s) of the reference frame of the multiple reference frames it is applied to.

In some embodiments, when MVDs are signaled for multiple reference frames, one (or more) flag(s)/index(s) may be signaled to indicate whether AMVD resolution is applied or not. For example, when MVDs are signaled for multiple reference frames (for example, in the NEW_NEWMV mode described above, or other compound-reference inter-prediction modes), one flag/index may be signaled in the video stream to indicate whether adaptive MVD resolution is applied to the signaling of MVDs for all of the multiple reference frames or not. If this flag/index is 1 (or 0), it indicates that adaptive MVD resolution is applied to the signaling of MVDs for all of the multiple reference frames. Otherwise, if this flag/index is 0 (or 1), AMVD coding is applied to the signaling of MVDs for none of the multiple reference frames. In such implementations, with respect to the multiple inter-prediction reference frames, the AMVD resolution is applied in an all-or-none scheme.

In some other examples, when MVDs are signaled for multiple reference frames (for example, in the NEW_NEWMV mode described above for two-reference frame compound inter-prediction mode) or other compound inter prediction modes), one flag/index may be signaled for each reference frame separately to indicate whether adaptive MVD resolution is applied to each reference frame or not. In such implementations, whether adaptive MVD resolution is applied or not may be determined individual for each of the reference frames. The decision of whether to apply the adaptive MVD resolution may be made at the encoder independently for each of the multiple reference frames and signaled separately in the video stream.

In some embodiments, when MVDs are signaled for multiple reference frames, for each of the multiple reference frames, if MVD for that reference frame is non-zero, one flag/index may be signaled to indicate whether adaptive MVD resolution is applied to that reference frame or not. Otherwise, no flag/index needs to be signaled. In other words, if the MVD for a particular reference frame is signaled/indicated as zero, then there is no need to determine whether adaptive MVD resolution is applied or not and thus there is no need for any corresponding signaling in the video stream. However, in such implementations, an indication that the MVD is zero need to be signaled prior to when the determination is made as to whether adaptive resolution is applied or not.

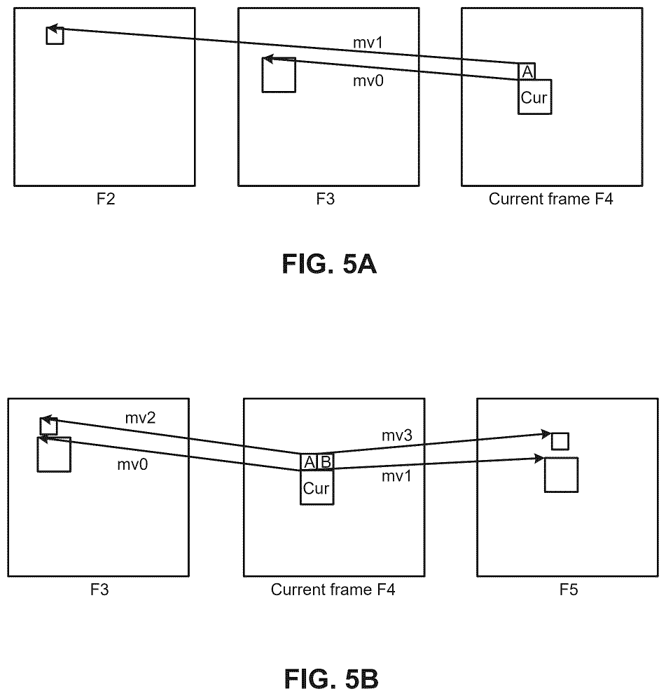

FIG. 6 illustrates an example TIP mode in accordance with some embodiments. In the example of FIG. 6, information in reference frames 604-1 and 604-2 is combined and projected to a same time instance as a current frame 602 using an interpolation process. In some embodiments, multiple TIP modes are supported. In a first example TIP mode, an interpolated frame 606 is used as an additional reference frame. A coding block of the current frame 602 may directly reference the interpolated frame 606 and thereby utilize the information coming from two different references with only the overhead cost of a single inter prediction mode. In another example TIP mode, the interpolated frame 606 is directly assigned as a decoded frame 608, the output of the decoding process for the current frame 602 (e.g., skipping other traditional coding steps such as generating residue blocks). This mode may provide considerable coding and simplification benefits, especially for low-bitrate applications. Other techniques may be used to interpolate a frame between two reference frames, such as Frame Rate Up Conversion (FRUC).

An example TIP mode includes generating an interpolated frame 606 corresponding to the current frame 602. The interpolated frame 606 may then be used as either an additional reference frame for the current frame 602 or be directly assigned as a reconstructed output of a decoder for the current frame 602. At the decoder side, the blocks coded in a TIP mode may be generated on-the-fly, such that it is not necessary to create the whole interpolated frame 506 at the decoder, conserving decoding time and processing. The frame level TIP mode may be indicated using a syntax element. Examples of modes, indicated by values for a tip_frame_mode parameter, are shown below in Table 4.

TABLE 4
Example TIP modes

| tip_frame_mode | Meaning |
|---|---|
| 0 | Disable TIP mode in this frame |
| 1 | Use TIP frame as an additional reference frame |
| 2 | Directly output TIP frame, no coding of the current |
| | frame |

An example interpolation method for interpolating an intermediate frame between two frames may reuse the motion vectors from the available references. The same motion vectors may also be used for the temporal motion vector predictor (TMVP) process after minor modification. For example, a coarse motion vector field may be created for the TIP frame through projection of the modified TMVP field. In this example, the coarse motion vector field refined by filling holes and using smoothing operations. In this example, the TIP frame is generated using the refined motion vector field. At the decoder side, the blocks coded with TIP mode may be generated on-the-fly without creating the whole TIP frame. However, other suitable interpolation methods may be substituted, in combination with other features discussed in this disclosure.

As discussed in FIG. 6, with forward and backward reference frame(s) (e.g., reference frames 604-1 and 604-2), a temporal interpolated predicted frame (TIP) such as the interpolated frame 606 can be interpolated. This TIP frame can serve as a reference frame, or to be directly output for display purpose (e.g., as TIP direct output mode). In some scenarios, there may be frame level displacement between the TIP frame 606 and the current frame 602. In some embodiments, frame level motion estimation can be performed to mitigate the issue. The decoder signals motion vectors in TIP as shown in Table 5 below.

```
TABLE 5
int all_zero = aom_rb_read_bit(rb);
if (! all_zero) {
  cm−>tip_global_motion .as_mv .rnw = aom_rb_read_literal(rb, 4);
  cm−>tip_global_motion .as_mv .col = aom_rb_read_literal(rb, 4);
  if (cm−>tip_global_motion .as_mv .row != 0) {
    int sign = aom_rb_read_bit (rb);
    if (sign) cm−>tip_global_motion .as_mv .row *= −1;
  }
  if (cm−>tip_global_motion .as_mv .col != 0) {
    int sign = aom_rb_read_bit(rb);
    if (sign) cm−>tip_global_motion .as_mv .col *= −1;
  }
}
```

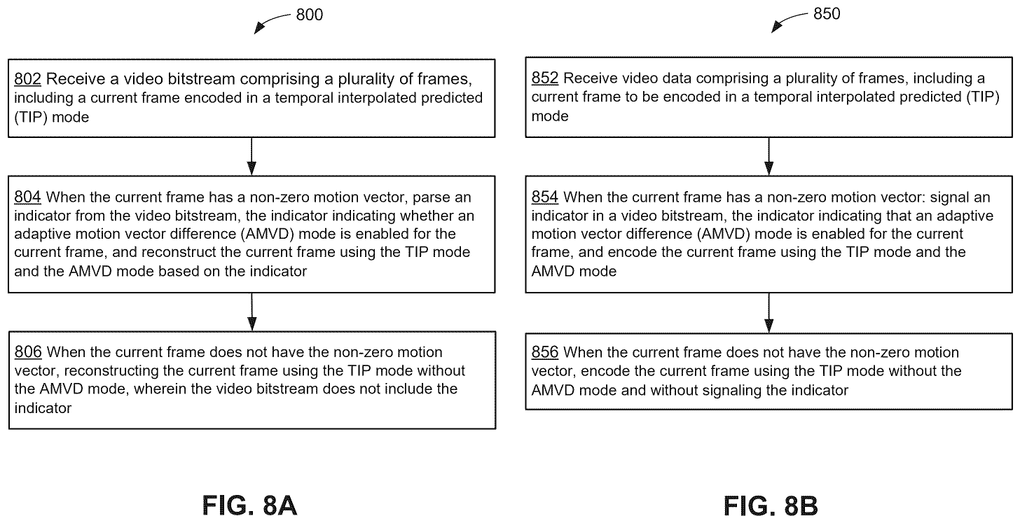

FIG. 8A is a flow diagram illustrating a method 800 of decoding video in accordance with some embodiments. The method 800 may be performed at a computing system (e.g., the server system 112, the source device 102, or the electronic device 120) having control circuitry and memory storing instructions for execution by the control circuitry. In some embodiments, the method 800 is performed by executing instructions stored in the memory (e.g., the memory 314) of the computing system.

The system receives (802) a video bitstream comprising a plurality of frames, including a current frame encoded in a TIP mode. When the current frame has a non-zero motion vector, the system parses (804) an indicator from the video bitstream, the indicator indicating whether an AMVD mode is enabled for the current frame, and reconstructs the current frame using the TIP mode and the AMVD mode based on the indicator. When the current frame does not have the non-zero motion vector, the system reconstructs (806) the current frame using the TIP mode without the AMVD mode, wherein the video bitstream does not include the indicator.

In some embodiments, when motion vectors are not zero, one flag may be signaled into the bitstream to indicate whether the AMVD method is applied to TIP direct output prediction mode. An index to a look-up table may be signaled to indicate the motion vector. The sign for the motion vector may be signaled. In some embodiments, motion vectors may be coarser when the magnitudes of motion vectors are larger, and motion vectors may be only on the axis. A sign can be signaled with 1 bit. In some embodiments, the number of the allowed motion vectors for the proposed AMVD based TIP direct output mode is equal to power of 2.

In some embodiments, the number of the allowed motion vectors in the proposed AMVD based TIP direct output mode is 16, and the index to the look-up table is signaled with 4 bits in the frame header. In one example, the look-up table is listed as follows {{1,0}, {2,0}, {4,0}, {6,0}, {8,0}, {16,0}, {32,0}, {64,0}, {0,1}, {0,2}, {0,4}, {0,6}, {0,8}, {0,16}, {0,32}, {0,64}}. This is also illustrated in Table 6 below. Note that these values do not represent the actual motion vector. Instead, the actual motion vector is derived by dividing the value in the look-up table by 8 or 16 or 4.

```
TABLE 6
  int all_zero = aom_rb_read_bit(rb);
  if (!all_zero) {
#if TIP_DIRECT_MV_IMPROVE
    cm−>tip_global_motion_amvd = aom_rb_read bit(rb);
    if (cm−>tip_global_motion_amvd){
      const int search_dir_improve[16] [2] = {
      { 64, 0 }, { 32, 0 }, { 16, 0 }, { 8, 0 }, { 6, 0 }, { 4, 0 }, { 2, 0 }, { 1, 0 },
      { 0, 64 }, { 0, 32 }, { 0, 16 }, { 0, 8 }, { 0, 6 }, { 0, 4 }, { 0, 2 }, { 0, 1 },
    };
    cm−>tip_global_motion_amvd_ind = aom_rb read_literal(rb, 4);
    int sign = aom_rb_read_bit(rb);
    cm−>tip_global_motion_amvd_sign = sign? −1:1;
    cm−>tip_global_motion.as_mv.row = cm−>tip_global_motion_amvd_sign *
    search_dir_improve[cm−>tip_global_motion_amvd_ind][0];
    cm−>tip_global_motion.as_mv.row = cm−>tip_global_motion_amvd_sign *
    search_dir_improve[cm−>tip_global_motion_amvd_ind][1];
```

In some embodiments, the number of the allowed motion vectors in the proposed AMVD based TIP direct output mode is 8, and the index to the look-up table is signaled with 3 bits in the frame header. In one example, the look-up table is {{1,0}, {2,0}, {4,0}, {8,0}, {0,1}, {0,2}, {0,4}, {0, 8}}. In another example, the look-up table is {{2,0}, {4,0}, {8,0}, {16,0}, {0,2}, {0,4}, {0,8}, {0,16}}. In another example, the look-up table is {{16,0}, {32,0}, {48,0}, {64,0}, {0,16}, {0,32}, {0,48}, {0,64}}. This is illustrated in Table 7 below. Note that these values do not represent the actual motion vector. Instead, the actual motion vector is derived by dividing the value in the look-up table by 8 or 16 or 4.

```
TABLE 7
  int all_zero = aom_rb_read_bit(rb);
  if (!all_zero) {
#if TIP_DIRECT_MV_IMPROVE
    cm−>tip_global_motion_amvd = aom_rb_read_bit(rb);
    if (cm−>tip_global_motion_amvd){
      const int search_dir_improve[8] [2] = {
      { 64, 0 }, { 48, 0 }, { 32, 0 }, { 16, 0 },
      { 0, 64 }, { 0, 48 }, { 0, 32 }, { 0, 16 },
    };
    cm−>tip_global_motion_amvd_ind = aom_rb read_literal(rb, 3);
    int sign = aom_rb_read_bit(rb);
    cm−>tip_global_motion_amvd_sign = sign? −1:1;
    cm−>tip_global_motion.as_mv.row = cm−>tip_global_motion_amvd_sign *
    search_dir_improve[cm−>tip_global_motion_amvd_ind][0];
    cm−>tip_global_motion.as_mv.row = cm−>tip_global_motion_amvd_sign *
    search_dir_improve[cm−>tip_global_motion_amvd_ind][1];
```

In some embodiments, when motion vectors for TIP direct output mode are not zero, the precision of the motion vectors may be coarser when the motion vector is larger. The index to the motion vector lookup table is signaled. Signs of the motion vector may also be signaled. In some embodiments, the allowed motion vectors are stored in one look-up table, and the x and y components of the motion vector can only take values from this look-up table. In one example, the look-up table is {0, 1, 2, 4, 8, 16, 32, 64}. This is illustrated in Table 8 below.

```
TABLE 8
  int all_zero = aom_rb_read_bit(rb);
  if (!all_zero) {
#if TIP_MV_FULL_SEARCH
    const int mv_sampling[ ] ={0, 1, 2, 4, 8, 16, 32, 64};
    int sign_array[2] = {−1, 1};
    cm−>best_idx_row = aom_rb_read_literal(rb,3);
    cm−>best_idx_col = aom_rb_read_literal(rb,3);
    cm−>best_idx_sign_row = aom_rb_read_literal(rb);
    cm−>tip_global_motion.as_mv.row = sign_array[cm−> best_idx_sign row] *
    mv_sampling[cm−>best_idx_row];
    cm−>best_idx_sign_col = aom_rb_read_literal(rb);
    cm−>tip_global_motion.as_mv.col = sign_array[cm−> best_idx_sign_col] *
    mv_sampling[cm−>best_idx_col];
```

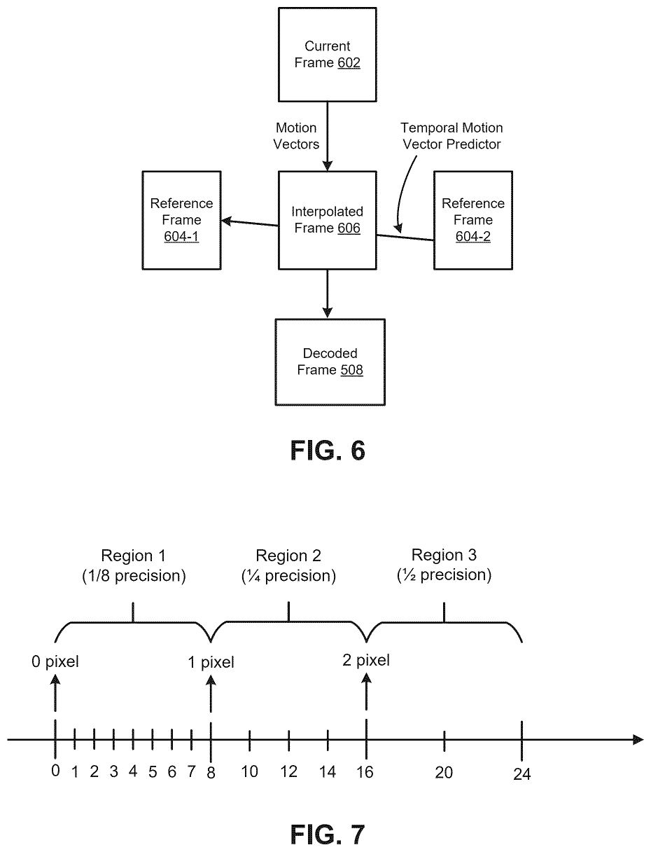

In some embodiments, the magnitude of the motion vector precision may be classified into multiple intervals (or regions), and the precision of the motion vector may be determined based on the region/interval in which one motion vector is located. FIG. 7 shows an example where the magnitudes of the motion vectors are classified into 3 regions. Assuming the motion vector precision in FIG. 7 is ⅛. When the magnitudes of the motion vectors are equal to or smaller than 1 pixel, the precision of the motion vectors are set to ⅛. Otherwise, when the magnitudes of the motion vectors are equal to or greater than 2 pixels, the precision of the motion vectors are set to ¼ pixel. Otherwise, the precision of the motion vectors is set to ½ pixel. In one embodiment, motion vector x and motion vector y can each take values from {0, 1, 2, 3, 4, 5, 6, 7, 8, 10, 12, 14, 16, 20, 24, 28, 32}. In one embodiment, motion vector x and motion vector y can each take values from {0, 1, 2, 3, 4, 5, 6, 7, 8, 10, 12, 14, 16, 24, 28}.

In some embodiments, when motion vectors for TIP direct output mode are not zero, one flag is signaled to indicate whether the first component of the motion vector is zero. When the first component of the motion vector is zero, the second (or other) component of the motion vector is derived as non-zero, and the magnitude and the sign of the second component of the motion vector may be further signaled. Otherwise, when the first component of motion vector is non-zero, the magnitude and sign value of the first component of motion vectors is signaled, followed by one flag indicating whether the second component of the motion vector is zero or not. When the second component of the motion vector is non-zero, the magnitude and sign of the second component of motion vector may be further signaled. In one embodiment, the first component is x component, and the second component is y component. In another embodiment, the first component is y component, and the second component is x component. In yet another embodiment, the magnitude of motion vector can be from the look up table {0, 1, 2, 3, 4, 5, 6, 7, 8, 9, 10, 11, 12, 13, 14, 15} and sign bits can be signaled. This is illustrated in Table 9.

```
TABLE 9
  int all_zero = aom_rb_read_bit(rb);
  if (!all_zero) {
#if TIP_MV_SIGNAL_AXIS_FIRST
    int is_row_zero = aom_rb_read_bit(rb);
    if (is_row_zero){
      cm−>tip_global_motion.as_mv.col = aom_rb_read_literal(rb, 4);
      sign = aom_rb_read_bit (rb) ;
      if (sign) cm−>tip_global_motion.as_mv.col *=−1;
    }else{
      cm−>tip_global_motion.as_mv.row = aom_rb_read_literal(rb, 4);
      int sign = aom_rb_read_bit(rb);
      if (sign) cm−>tip_global_motion.as_mv.row *= −1;
      int is_col_zero = aom_rb_read_bit(rb);
      if(!is_col_zero){
        cm−>tip_global_motion. as_mv.col = aom_rb_read_literal(rb, 4);
        int sign = aom_rb_read_bit(rb);
        if (sign) cm−>tip_global_motion.as_mv.col *= −1;
      }
    }
```

In some embodiments, the allowed magnitude of each component of motion vector may be stored in the pre-defined look up table. In some embodiments, the lookup table can be {0, 1, 2, 3, 4, 5, 6, 7, 8, 10,12, 14, 16, 24, 28, 32}. In one example, the lookup table can be {0, 1, 2, 3, 4, 5, 6, 7, 8, 10, 12, 14, 16, 32, 48, 64}. In another example, the lookup table can be {0, 1, 2, 4, 8, 16, 32, 64}. In another example, the lookup table can be {1, 2, 4, 6, 8, 16, 32, 64}. In another example, the lookup table can be {1, 2, 4, 8}. In another example, the lookup table can be {2, 4, 8, 16}. In yet another example, the lookup table can be {16, 32, 48, 64}.

FIG. 8B is a flow diagram illustrating a method 850 of encoding video in accordance with some embodiments. The method 850 may be performed at a computing system (e.g., the server system 112, the source device 102, or the electronic device 120) having control circuitry and memory storing instructions for execution by the control circuitry. In some embodiments, the method 750 is performed by executing instructions stored in the memory (e.g., the memory 314) of the computing system. In some embodiments, the method 850 is performed by a same system as the method 800 above.

The system receives (852) video data comprising a plurality of frames, including a current frame to be encoded in a TIP mode. When the current frame has a non-zero motion vector, the system signals (854) an indicator in a video bitstream, the indicator indicating that an AMVD mode is enabled for the current frame, and encodes the current frame using the TIP mode and the AMVD mode. When the current frame does not have the non-zero motion vector, the system encodes (856) the current frame using the TIP mode without the AMVD mode and without signaling the indicator. As described previously, the encoding process may mirror the decoding processes described herein (e.g., motion vector estimation and TIP mode). For brevity, those details are not repeated here.

Although FIGS. 8A and 8B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.
(A1) In one aspect, some embodiments include a method (e.g., the method 800) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream (e.g., a coded video sequence) comprising a plurality of frames, including a current frame encoded in a TIP mode; (ii) when the current frame has a non-zero motion vector: (a) parsing an indicator from the video bitstream, the indicator indicating whether an AMVD mode is enabled for the current frame; and (b) reconstructing the current frame using the TIP mode and the AMVD mode based on the indicator; and (iii) when the current frame does not have the non-zero motion vector, reconstructing the current frame using the TIP mode without the AMVD mode, wherein the video bitstream does not include the indicator. In this way, when motion vectors are not zero, a flag may be signaled into the bitstream to indicate whether the AMVD method is applied to TIP direct output prediction mode. In some embodiments, the video bitstream includes an index to a look-up table for the motion vector. In some embodiments, the video bitstream includes a sign for the motion vector.
(A2) In some embodiments of A1, wherein, in the AMVD mode, a precision of the non-zero motion vector decreases as a magnitude of the non-zero motion vector increases. For example, motion vectors may be coarser when the magnitudes of motion vectors are larger, and motion vectors may be only on the axis. A sign can be signaled with 1 bit.
(A3) In some embodiments of A2, the precision of the non-zero motion vector is based on which interval of a set of intervals the magnitude of the non-zero motion vector is within. For example, the magnitude of the motion vector precision may be classified into multiple intervals (or regions), and the precision of the motion vector may be determined based on the region/interval in which one motion vector is located. As an example, the magnitudes of the motion vectors are classified into 3 regions. Assuming the motion vector precision is ⅛. When the magnitudes of the motion vectors are equal to or smaller than 1 pixel, the precision of the motion vectors are set to ⅛. Otherwise, when the magnitudes of the motion vectors are equal to or greater than 2 pixels, the precision of the motion vectors are set to ¼ pixel. Otherwise, the precision of the motion vectors is set to ½ pixel.
(A4) In some embodiments of any of A1-A3, reconstructing the current frame using the TIP mode and the AMVD mode comprises determining a value of the non-zero motion vector from a set of values, and wherein the set of values has a size equal to a power of 2. For example, the number of the allowed motion vectors for the AMVD-based TIP direct output mode is equal to power of 2.
(A5) In some embodiments of A4, the set of values has a size equal to 16. For example, the number of the allowed motion vectors in the AMVD-based TIP direct output mode is 16, and the index to the look-up table is signaled with 4 bits in the frame header. As an example, the look-up table may comprise {{1,0}, {2,0}, {4,0}, {6,0}, {8,0}, {16,0}, {32,0}, {64,0}, {0,1}, {0,2}, {0,4}, {0,6}, {0,8}, {0,16}, {0,32}, {0,64}}. Note that these values do not represent the actual motion vector. Instead, the actual motion vector is derived by dividing the value in the look-up table by 8 or 16 or 4.
(A6) In some embodiments of A4, the set of values has a size equal to 8. For example, the number of the allowed motion vectors in the proposed AMVD based TIP direct output mode is 8, and the index to the look-up table is signaled with 3 bits in the frame header. As an example, the look-up table is {{1,0}, {2,0}, {4,0}, {8,0}, {0,1}, {0,2}, {0,4}, {0,8}}. As another example, the look-up table is {{2,0}, {4,0}, {8,0}, {16,0}, {0,2}, {0,4}, {0,8}, {0,16}}. As another example, the look-up table is {{16,0}, {32,0}, {48,0}, {64,0}, {0,16}, {0,32}, {0,48}, {0,64}}. Note that these values do not represent the actual motion vector. Instead, the actual motion vector is derived by dividing the value in the look-up table by 8 or 16 or 4.
(A7) In some embodiments of any of A1-A6, the method further comprises parsing a second indicator from the video bitstream, the second indicator indicating an index to a motion vector look-up table. For example, when motion vectors for TIP direct output mode are not zero, the precision of the motion vectors may be coarser when the motion vector is larger. The index to the motion vector look-up table is signaled. As an example, the allowed motion vectors may be stored in one look-up table, and the x and y components of the motion vector can only take values from the look-up table. As an example, the look-up table may be {0, 1, 2, 4, 8, 16, 32, 64}. Note that these values do not represent the actual motion vector. Instead, the actual motion vector is derived by dividing the value in the look-up table by 8 or 16 or 4.
(A8) In some embodiments of A7, the method further comprises parsing a third indicator from the video bitstream, the third indicator indicating a sign of the non-zero motion vector. For example, signs of the motion vector may also be signaled.
(A9) In some embodiments of any of A1-A8, horizontal and vertical components of the non-zero motion vector have respective values selected from a set of predefined values. For example, motion vector x and motion vector y can each take value from {0, 1, 2, 3, 4, 5, 6, 7, 8, 10, 12, 14, 16, 20, 24, 28, 32}. As another example, motion vector x and motion vector y can each take value from {0, 1, 2, 3, 4, 5, 6, 7, 8, 10, 12, 14, 16, 24, 28}. Note that these values do not represent the actual motion vector. Instead, the actual motion vector is derived by dividing the value in the look-up table by 8 or 16 or 4.
(A10) In some embodiments of A9, the horizontal and vertical components are determined from a look-up table. For example, the magnitude of motion vector can be from the look up table {0, 1, 2, 3, 4, 5, 6, 7, 8, 9, 10, 11, 12, 13, 14, 15} and sign bits can be signaled. Note that these values do not represent the actual motion vector. Instead, the actual motion vector is derived by dividing the value in the look-up table by 8 or 16 or 4.
(A11) In some embodiments of any of A1-A10, the method further comprises determining whether the current frame has a non-zero motion vector based on a second indicator in the video bitstream. For example, when motion vectors for TIP direct output mode are not zero, a flag may be signaled to indicate whether the first component of the motion vector is zero. When the first component of the motion vector is zero, the second (or other) component of the motion vector is derived as non-zero, and the magnitude and the sign of the second component of the motion vector may be further signaled. Otherwise, when the first component of motion vector is non-zero, the magnitude and sign value of the first component of motion vectors is signaled, followed by one flag indicating whether the second component of the motion vector is zero or not. When the second component of the motion vector is non-zero, the magnitude and sign of the second component of motion vector may be further signaled. As an example, the first component is x component, and the second component is y component. As another example, the first component is y component, and the second component is x component.
(A12) In some embodiments of any of A1-A11, the method further comprises determining a magnitude of the non-zero motion vector using a look-up table. For example, the allowed magnitude of each component of motion vector may be stored in the pre-defined look up table. As an example, the look-up table may be {0, 1, 2, 3, 4, 5, 6, 7, 8, 10, 12, 14, 16, 24, 28, 32}. As another example, the look-up table may be {0, 1, 2, 3, 4, 5, 6, 7, 8, 10, 12, 14, 16, 32, 48, 64}. As another example, the look-up table may be {0, 1, 2, 4, 8, 16, 32, 64}. As another example, the look-up table may be {1, 2, 4, 6, 8, 16, 32, 64}. As another example, the look-up table may be {1, 2, 4, 8}. As another example, the look-up table may be {2, 4, 8, 16}. As another example, the look-up table may be {16, 32, 48, 64}. Note that these values do not represent the actual motion vector. Instead, the actual motion vector is derived by dividing the value in the look-up table by 8 or 16 or 4.
(B1) In another aspect, some embodiments include a method (e.g., the method 850) of video encoding. In some embodiments, the method is performed at a computing system (e.g., the server system 112) having memory and control circuitry. In some embodiments, the method is performed at a coding module (e.g., the coding module 320). The method includes: (i) receiving video data (e.g., a source video sequence) comprising a plurality of frames, including a current frame to be encoded in a TIP mode; (ii) when the current frame has a non-zero motion vector: (a) signaling an indicator in a video bitstream, the indicator indicating that an AMVD mode is enabled for the current frame; and (b) encoding the current frame using the TIP mode and the AMVD mode; and (iii) when the current frame does not have the non-zero motion vector, encoding the current frame using the TIP mode without the AMVD mode and without signaling the indicator. In some embodiments, the method further includes transmitting encoded information for the current frame in a video bitstream.
(B2) In some embodiments of B1, in the AMVD mode, a precision of the non-zero motion vector decreases as a magnitude of the non-zero motion vector increases.
(B3) In some embodiments of B1 or B2, reconstructing the current frame using the TIP mode and the AMVD mode comprises determining a value of the non-zero motion vector from a set of values, and wherein the set of values has a size equal to a power of 2.
(B4) In some embodiments of any of B1-B3, the method further comprises signaling a second indicator in the video bitstream, the second indicator indicating an index to a motion vector look-up table.
(B5) In some embodiments of any of B1-B4, horizontal and vertical components of the non-zero motion vector have respective values selected from a set of predefined values
(B6) In some embodiments of any of B1-B5, the method further comprises determining a magnitude of the non-zero motion vector using a look-up table.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A12 and B1-B6 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A12, and B1-B6 above). In some embodiments, a memory or non-transitory computer-readable storage medium stores a video bitstream including any of the features (e.g., syntax and encoded information) disclosed herein.

Unless otherwise specified, any of the syntax elements (e.g., indicators) described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of frames, including a current frame encoded in a temporal interpolated predicted (TIP) mode;
when the current frame has a non-zero motion vector:
parsing an indicator from the video bitstream, the indicator indicating whether an adaptive motion vector difference (AMVD) mode is enabled for the current frame; and
reconstructing the current frame using the TIP mode and the AMVD mode based on the indicator; and
when the current frame does not have the non-zero motion vector, reconstructing the current frame using the TIP mode without the AMVD mode, wherein the video bitstream does not include the indicator.

2. The method of claim 1, wherein, in the AMVD mode, a precision of the non-zero motion vector decreases as a magnitude of the non-zero motion vector increases.

3. The method of claim 2, wherein the precision of the non-zero motion vector is based on which interval of a set of intervals the magnitude of the non-zero motion vector is within.

4. The method of claim 1, wherein reconstructing the current frame using the TIP mode and the AMVD mode comprises determining a value of the non-zero motion vector from a set of values, and wherein the set of values has a size equal to a power of 2.

5. The method of claim 4, wherein the set of values has a size equal to 16.

6. The method of claim 4, wherein the set of values has a size equal to 8.

7. The method of claim 1, further comprising parsing a second indicator from the video bitstream, the second indicator indicating an index to a motion vector look-up table.

8. The method of claim 7, further comprising parsing a third indicator from the video bitstream, the third indicator indicating a sign of the non-zero motion vector.

9. The method of claim 1, wherein horizontal and vertical components of the non-zero motion vector have respective values selected from a set of predefined values.

10. The method of claim 9, wherein the horizontal and vertical components are determined from a look-up table.

11. The method of claim 1, further comprising determining whether the current frame has a non-zero motion vector based on a second indicator in the video bitstream.

12. The method of claim 1, further comprising determining a magnitude of the non-zero motion vector using a look-up table.

13. A method of video encoding performed at a computing system having memory and one or more processors, the method comprising:
receiving video data comprising a plurality of frames, including a current frame to be encoded in a temporal interpolated predicted (TIP) mode;
when the current frame has a non-zero motion vector:
signaling an indicator in a video bitstream, the indicator indicating that an adaptive motion vector difference (AMVD) mode is enabled for the current frame; and
encoding the current frame using the TIP mode and the AMVD mode; and
when the current frame does not have the non-zero motion vector, encoding the current frame using the TIP mode without the AMVD mode and without signaling the indicator.

14. The method of claim 13, wherein, in the AMVD mode, a precision of the non-zero motion vector decreases as a magnitude of the non-zero motion vector increases.

15. The method of claim 13, wherein reconstructing the current frame using the TIP mode and the AMVD mode comprises determining a value of the non-zero motion vector from a set of values, and wherein the set of values has a size equal to a power of 2.

16. The method of claim 13, further comprising signaling a second indicator in the video bitstream, the second indicator indicating an index to a motion vector look-up table.

17. The method of claim 13, wherein horizontal and vertical components of the non-zero motion vector have respective values selected from a set of predefined values.

18. The method of claim 13, further comprising determining a magnitude of the non-zero motion vector using a look-up table.

19. A non-transitory computer-readable storage medium storing a video bitstream that is generated by a video encoding method, the video bitstream comprising:
coded information for a plurality of frames including a current frame encoded in a temporal interpolated predicted (TIP) mode; and
when the current frame has a non-zero motion vector, an indicator indicating that an adaptive motion vector difference (AMVD) mode is enabled for the current frame;
wherein the video encoding method comprises:
when the current frame has a non-zero motion vector:
signaling the indicator in a video bitstream; and
encoding the current frame using the TIP mode and the AMVD mode; and
when the current frame does not have the non-zero motion vector, encoding the current frame using the TIP mode without the AMVD mode and without signaling the indicator.

20. The non-transitory computer-readable storage medium of claim 19, wherein the video bitstream further comprises a second indicator indicating an index to a motion vector look-up table for the current frame.
